(19) United States
(12) Patent Application Publication
(10) Pub. No.: US 2018/0040027 A1
(43) Pub. Date: Feb. 8, 2018

(54) RETARGETING ADVERTISING PRODUCT RECOMMENDING USER DEVICE AND SERVICE PROVIDING DEVICE, ADVERTISING PRODUCT RECOMMENDING SYSTEM INCLUDING THE SAME, CONTROL METHOD THEREOF, AND NON-TRANSITORY COMPUTER READABLE STORAGE MEDIUM HAVING COMPUTER PROGRAM RECORDED THEREON

(71) Applicant: SK PLANET CO., LTD., Seongnam-si, Gyeonggi-do (KR)

(72) Inventor: Min Ho HAN, Seoul (KR)

(73) Assignee: SK Planet Co., Ltd., Seongnam-si, Gyeonggi-do (KR)

(21) Appl. No.: 15/320,594

(22) PCT Filed: Dec. 7, 2015
(86) PCT No.: PCT/KR2015/013333

§ 371 Date: Dec. 20, 2016

(30) Foreign Application Priority Data
Apr. 30, 2015 (KR) 10-2015-0061020

(51) Int. Cl. G06Q 30/02; G06Q 30/06

(52) U.S. Cl. CPC G06Q 30/0268; G06Q 30/0631; G06Q 30/0282; G06Q 30/0238

(57) ABSTRACT

Provided are a retargeting advertising product recommending user device and service providing device, an advertising product recommending system including the same, a control method thereof, and a non-transitory computer readable storage medium having a computer program recorded thereon. That is, according to the present invention, it is possible to extract an advertising targeting set personalized based on a food list and payment information provided after having a meal at a store of an advertiser and provide the extracted advertising targeting to a terminal corresponding to the corresponding payment information, thereby inducing the user of the terminal to revisit the restaurant and calculating an advertising cost only for a food ordered through the advertising to reasonably set the advertising cost.

### TECHNICAL FIELD

The present invention relates to retargeting advertising product recommending user device, and service providing device, an advertising product recommending system including the same, a control method thereof, and a non-transitory computer readable storage medium having a computer program recorded thereon, and more particularly, to a retargeting advertisingproductrecommendinguserdeviceandaserviceprovidingdevice which extract an advertising targeting set personalized based on a food list and payment information provided after having a meal at a store of an advertiser and provide the extracted advertising targeting to a terminal corresponding to the corresponding payment information, an advertising product recommending system including the same, a control method thereof, and a non-transitory computer readable storage medium having a computer program recorded thereon.

### BACKGROUND ART

A retargeting advertising system is a system which, when a user views a product through a site A and then accesses another site B or C, exposes the product viewed through the site A in another site B or C as an advertising.

The above-described retargeting advertising system induces the user to a product purchasing site using an intuitive memory for a product of interest of the user. However, since a product of interest of the user is mainly recommended as the retargeting advertising product, the advertising which is led to actual purchase is not so much and thus the effect of the advertising is lowered.

### RELATED ART DOCUMENT

### Patent Document

Korean Unexamined Patent Application Publication No. 10-2000-0030058 (entitled Advertising system and method using Internet web page]

### DISCLOSURE

### Technical Problem

An object of the present invention is to provide a retargeting advertisingproductrecommendinguserdeviceandaserviceprovidingdevice which extract an advertising targeting set personalized based on a food list and payment information provided after having a meal at a store of an advertiser and provide the extracted advertising targeting to a terminal corresponding to the corresponding payment information, an advertising product recommending system including the same, a control method thereof, and a non-transitory computer readable storage medium having a computer program recorded thereon.

Another object of the present invention is to provide a retargeting advertisingproductrecommendinguserdeviceandaserviceprovidingdevice which provide a product to a store of an advertiser as an advertising and configure a retargeting platform in an online to offline or offline to online (O2O) market to collect feedback of a customer and provide a coupon, an advertising product recommending system including the same, a control method thereof, and a non-transitory computer readable storage medium having a computer program recorded thereon.

### Technical Solution

According to an aspect of the present invention, a service providing device includes: a storage unit which stores information related to a store equipped with a POS terminal including total payment amount information which is paid through the store equipped with the POS terminal for a predetermined period, a number of one or more ordered products provided from the store, an entire food price paid at every date in the store, and order information or payment information for every terminal which makes a payment in the store; a communication unit which receives response information, payment information, and store information which are transmitted from the POS terminal and generated by a user device; and a control unit which selects a customer satisfying food item, an association analysis based food item, and the most popular food item of a store of an advertiser based on the received response information, payment information, and store information and information related to the store equipped with the POS terminal which is stored in advance in the storage unit, calculates an advertising exposing time of an advertising corresponding to the selected product for every recommendation type respectively, and controls the communication unit to provide the advertising corresponding to the selected product for every recommendation type according to the calculated advertising exposing time to one or more user devices.

In an embodiment of the present invention, the control unit may calculate a personal food satisfaction score for every product corresponding to the customer satisfying food item based on the food satisfaction score for every product included in the response information, payment date and time information included in the payment information, price information for every order product included in the payment information, and the entire food price paid at every date in the store which is stored in the storage unit, check at least one personal food satisfaction score corresponding to a predetermined number of higher personal food satisfaction scores among a plurality of personal food satisfaction scores calculated for every user, check the product name corresponding to the at least one checked personal food satisfaction score respectively, and select the checked product name as a customer satisfying product.

In an embodiment of the present invention, the control unit may calculate a plurality of Euclid distance based similarity based on the calculated personal food satisfaction score and the personal food satisfaction score calculated for the product name ordered by another user device which is stored in advance in the storage unit, calculate a total scores for every user based on the calculated Euclid distance based similarity for the plurality of products, check at least one user corresponding to another predetermined number of higher total scores among the calculated total scores for every user, and select a product which is not ordered in the user device, among the plurality of products ordered by at least one user, based on the payment information paid by the checked at least one user, as an association analysis based recommended product.

In an embodiment of the present invention, the control unit may calculate a customer satisfaction score for every foodbased on the personal food satisfaction score calculated for the user device, the personal food satisfaction score calculated for the product name ordered by another user device which is stored in advance in the storage unit, a click through rate (CTR) for every product, and a number of times of downloading a coupon for every product, check at least one customer satisfaction score for every product corresponding to another predetermined number of higher customer satisfaction scores for every food among the calculated customer satisfaction scores for every food, and select at least one product corresponding to the checked at least one customer satisfaction score for every product as the most popular product of the store of the advertiser.

In an embodiment of the present invention, the control unit may calculate the advertising exposing time of the advertising corresponding to the product for every recommendation type based on the click through rate of the advertising corresponding to the product for every recommendation type, the click through rate of the advertising corresponding to the entire products for every recommendation type, and the entire impressions of the advertising corresponding to the product for every recommendation type.

According to another aspect of the present invention, a control method of a service providing device includes: receiving response information, payment information, and store information which are transmitted from a POS terminal and generated in a user device, by means of a communication unit; selecting one or more products for every recommendation type respectively, including a customer satisfying food item, an association analysis based food item, and the most popular food item of a store of an advertiser based on the received response information, payment information, and store information and information related to the store equipped with the POS terminal which is stored in advance in the storage unit, by mean of the control unit; calculating the advertising exposing time of the advertising corresponding to the selected product for every recommendation type respectively based on the click through rate of the advertising corresponding to the product for every recommendation type, the click through rate of the advertising corresponding to the entire products for every recommendation type, and the entire impressions of the advertising corresponding to the product for every recommendation type, by means of the control unit; and providing the advertising corresponding to the selected product for every recommendation type according to the calculated advertising exposing time to one or more user devices, by means of the control unit.

In an embodiment of the present invention, the selecting of one or more products for every recommendation type may include, by means of the control unit, calculating a personal food satisfaction score corresponding to the customer satisfying food item based on the food satisfaction score for every product included in the response information, payment date and time information included in the payment information, price information for every order product included in the payment information, and the entire food price paid at every date in the store which is stored in advance in the storage unit; checking at least one personal food satisfaction score corresponding to the predeterminednumber of higher personal food satisfaction scores among a plurality of personal food satisfaction score calculated for every user; checking respectively the product name corresponding to the checked at least one personal food satisfaction score; and selecting the checked product name as a customer satisfying product.

In an embodiment of the present invention, the selecting of one or more products for every recommendation type respectively includes: by means of the control unit, calculating a plurality of Euclid distance based similarity based on the calculated personal food satisfaction score for every product and the personal food satisfaction score calculated for a product name which is ordered in another user device stored in advance in a storage unit; calculating a total scores for every user based on the calculated Euclid distance based similarity for the plurality of products; checking at least one user corresponding to the predetermined number of higher total scores, among the calculated total scores for every user; and selecting a product which is not ordered in the user device, among a plurality of products ordered by at least one user as an association analysis based recommendation product based on the checked payment information paid by the at least one user.

In an embodiment of the present invention, the selecting of one or more products for every recommendation type respectively may include: by means of the control unit, calculating a customer satisfaction score for every food, based on the personal food satisfaction score calculated for the user device, a personal food satisfaction score calculated for the product name ordered by another user device which is stored in advance in a storage unit, a click through rate (CTR) for every product, and a number of times of downloading the coupon for every product, by means of the control unit; checking at least one customer satisfaction score for every product corresponding to another predetermined number of higher customer satisfaction scores for every food, among the calculated customer satisfaction scores for every food; and selecting at least one product corresponding to checked at least one customer satisfaction score for every product as the most popular product in the store of the advertiser.

According to yet another aspect of the present invention, a computer program executing the methods according to the aforementioned embodiments may be stored in a non-transitory computer readable storage medium having a computer program recorded thereon.

According to still another aspect of the present invention, an advertising product recommending system includes: a user device which transmits response information for evaluation information which is transmitted correspondingly to order information; a POS terminal which performs a payment function for a payment amount corresponding to the order information by interworking with the user device, and transmits the response information, payment information, and store information; a service providing device which selects a customer satisfying food item, an association analysis based food item, and the most popular food item of a store of an advertiser based on the received response information, payment information, and store information and information related to the store equipped with the POS terminal which is stored in advance, calculates an advertising exposing time of an advertising corresponding to the selected product for every recommendation type respectively, and provides the advertising corresponding to the selected product for every recommendation type according to the calculated advertising exposing time to one or more user devices; and an advertising terminal which performs an advertising cost calculating function corresponding to a number of actually used coupons, by interworking with the service providing device.

### Advantageous Effects

According to the present invention, it is possible to extract an advertising targeting set personalized based on a food list and payment information provided after having a meal at a store of an advertiser and provide the extracted advertising targeting to a terminal corresponding to the corresponding payment information, thereby inducing the user of the terminal to revisit the restaurant and calculating an advertising cost only for a food ordered through the advertising to reasonably set the advertising cost.

Further, according to the present invention, it is possible to provide the product to a store of an advertiser as an advertising and configure a retargeting platform in an online to offline or offline to online (O2O) market to collect feedback of a customer and provide a coupon, thereby maximizing an advertising effect and increasing satisfaction of a user.

### BRIEF DESCRIPTION OF THE DRAWINGS

FIG. 1 is a block diagram illustrating a configuration of an advertising product recommending system according to an embodiment of the present invention.

FIG. 2 is a block diagram illustrating a configuration of a user device according to an embodiment of the present invention.

FIG. 3 is a block diagram illustrating a configuration of a service providing device according to an embodiment of the present invention.

FIGS. 4A and 4B are flowcharts illustrating a control method of a retargeting advertising product recommending system according to an embodiment of the present invention.

FIGS. 5 and 6 are views illustrating a screen of a user device according to an embodiment of the present invention.

FIG. 7 is a view illustrating a screen of a service providing device according to an embodiment of the present invention.

### MODE FOR INVENTION

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not be included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

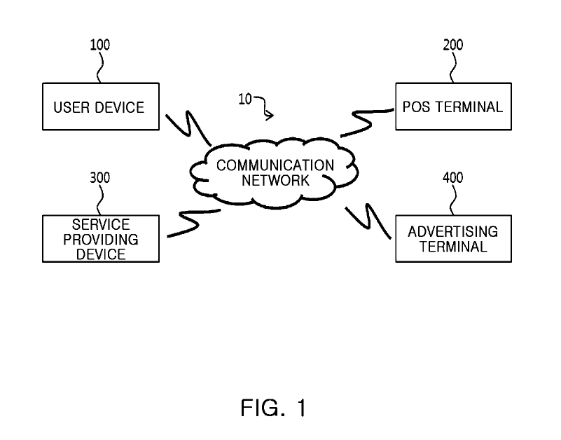

FIG. 1 is a block diagram illustrating a configuration of an advertising product recommending system 10 according to an embodiment of the present invention.

As illustrated in FIG. 1, the advertising product recommending system 10 includes a user device 100, a POS terminal 200, a service providing device 300, and an advertising terminal 400. All the constituent elements of the advertising product recommending system 10 illustrated in FIG. 1 are not essential constituent elements, and the advertising product recommending system 10 may be implemented by more constituent elements than the constituent elements illustrated in FIG. 1 or less constituent elements therethan.

The user device 100 and the POS terminal 200 interwork with each other to perform an order function for a product in a store equipped with the POS terminal 200, a survey function for an ordered product, and a payment function. Thereafter, the POS terminal 200 transmits response information in accordance with the survey function, payment information in accordance with the payment function, store information, and the like, to the service providing device 300. Thereafter, the service providing device 300 selects at least one product (or food) for every recommendation type including a customer satisfying food, an association analysis based food, and the most popular food in a store of an advertiser based on the response information, the payment information, the store information which are transmitted from the POS terminal 200, and information related to the corresponding store which is stored in advance in the service providing device 300. Thereafter, the service providing device 300 calculates an advertising exposing time of an advertising corresponding to a product for every recommendation type. Thereafter, the service providing device 300 provides an advertising corresponding to a product for every recommendation type which is previously selected based on the calculated advertising exposing time to one or more user devices 100. Thereafter, the one or more user devices 100 respectively displays the advertising corresponding to the product for every recommendation type which is provided from the service providing device 300. Thereafter, the service providing device 300 recalculates the advertising exposing time of the advertising corresponding to the product for every recommendation type which is previously selected in accordance with a click through rate with respect to advertisings having a high click through rate and provides the advertising corresponding to the corresponding product for every recommendation type according to the recalculated advertising exposing time to the one or more user devices 100. Thereafter, the service providing device 300 and the advertising terminal 400 interwork with each other to perform the advertising cost calculating function according to the number of times of actually clicking the advertising.

The user device 100 and/or the advertising terminal 400 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (for example, including a smart watch, a smart glass, or a head mounted display (HMD)), a Wibro terminal, an internet protocol television (IPTV) terminal, a smart TV, a digital broadcasting terminal, a television, a 3D television, a home theater system, an audio video navigation (AVN) terminal, an audio/video (A/V) system, and a flexible terminal.

Further, the user device 100 and/or the advertising terminal 400 may be a terminal including a memory in which a browser, a program, and a protocol are stored to communicate with the service providing device 300 via a communication network and a microprocessor which executes various programs to perform calculation and control.

That is, if it is possible to communicate with the service providing device 300, any of terminals may be used as the user device 100 and/or the advertising terminal 400.

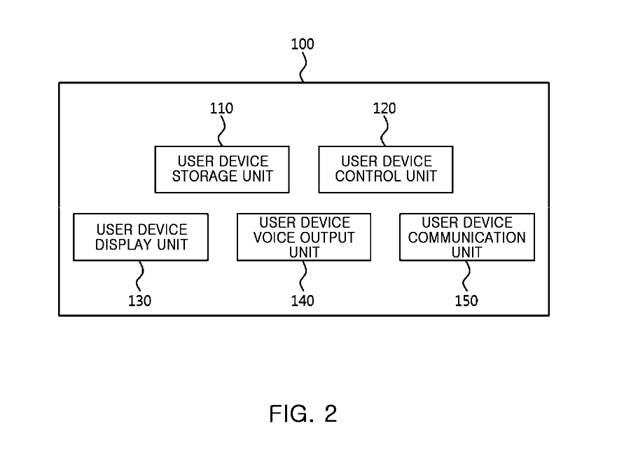

As illustrated in FIG. 2, the user device 100 is constituted by a user device storage unit 110, a user device control unit 120, a user device display unit 130, a user device voice output unit 140, and a user device communication unit 150. However, all the constituent elements of the user device 100 illustrated in FIG. 2 are not essential constituent elements, and the user device 100 may be implemented by more constituent elements than the constituent elements illustrated in FIG. 2 or less constituent elements therethan.

The user device storage unit 110 stores various user interfaces UI and graphic user interfaces GUI.

Further, the user device storage unit 110 stores data and programs required to operate the user device 100.

That is, the user device storage unit 110 may store a plurality of application programs (or applications) which are driven in the user device 100 and data and commands for operation of the user device 100. At least some of the application programs may be downloaded from an external server through wireless communication. In the meantime, the application program is stored in the user device storage unit 110 and provided in the user device 100 to be driven to perform an operation (or a function) of the user device 100 by the user device control unit 120.

Further, the user device storage unit 110 may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user device 100 may operate a web storage which performs a storing function of the user device storage unit 110 on the Internet or operate in association with the web storage.

Further, the user device storage unit 110 stores a discount coupon issued by the POS terminal 200 by the control of the user device control unit 120.

The user device control unit 120 performs an overall control function of the user device 100.

Further, the user device control unit 120 performs an overall control function of the user device 100 using a program and data stored in the user device storage unit 110. The user device control unit 120 may include a RAM, a ROM, a CPU, a GPU, and a bus and the RAM, the ROM, the CPU, the GPU, and the like are connected to each other through the bus. The CPU accesses the user device storage unit 110 to perform booting using an O/S stored in the user device storage unit 110 and performs various operations using various programs, contents, and data stored in the user device storage unit 110.

Further, the user device control unit 120 interlocks with the service providing device 300 to perform a member joining procedure for the user of the user device 100.

Further, when the member joining procedure is performed, the user device control unit 120 normally completes the member joining procedure for the service providing device 300 only by completing an authentication function through a self-authentication unit (for example, including a mobile phone, a credit card, I-PIN, e-mail, and the like).

Further, when an application which is installed in advance in the user device 100 is executed, the user device control unit 120 displays an application executing result screen on the user device display unit 130.

Further, the user device control unit 120 controls the user device communication unit 150 to connect the POS terminal 200 and the service providing device 300 (or perform a communication function with the POS terminal 120 and the service providing device 300).

Further, the user device control unit 120 controls the user device communication unit 150 to receive one or more product information and a table number which are transmitted from a beacon (not illustrated) adjacent to (or disposed/provided in) a table in a store and are provided from the store. Here, the product information includes a product name, a product unique code, a product image, and product description information.

Further, the user device control unit 120 displays the one or more product information, the table number, and the like which are previously received through a specific application which is installed in advance in the user device 100, on the user device display unit 130.

Further, at least one product information is selected from the one or more product information displayed on the user device display unit 130 and a quantity (or a quantity for every product) corresponding to selected at least one product information is selected. Thereafter, the user device control unit 120 controls the user device communication unit 150 to transmit order information including a product name (or an ordered product name) included in the selected at least one product information, the product unique code (or the ordered product unique code), an order quantity, a table number, and identification information of the user device 100 to the POS terminal 200 through the beacon. Here, the identification information of the user device 100 includes a mobile directory number (MDN), a mobile IP, a mobile MAC, a subscriber identify module (Sim) card unique information, and a serial number.

Further, the user device control unit 120 receives evaluation information transmitted from the POS terminal 200 via the beacon in response to the transmitted order information, by means of the user device communication unit 150. Here, the evaluation information includes an evaluation product item, an evaluation product unique code, a scoring item for every evaluation product, and the table number.

Further, the user device control unit 120 outputs the received evaluation information by means of the user device display unit 130 and/or the user device voice output unit 140.

Further, the user device control unit 120 transmits the response information to the POS terminal 200 by means of the user device communication unit 150 in response to the received evaluation information. Here, the response information includes a product name included in at least one product information, a product unique code, a food satisfaction score for every product, the table number, and the identification information of the user device 100.

That is, the user device control unit 120 controls the user device communication unit 150 to transmit an evaluation product item included in the received evaluation information, a food satisfaction score for every food in accordance with a user input for the scoring item for every evaluation product, at least one product name corresponding to the evaluation product item, the product unique code, the table number, and the identification information of the user device 100 to the POS terminal 200 via the beacon.

Further, the user device control unit 120 receives a predetermined point and/or a discount coupon provided (or issued) from the POS terminal 200 in response to the transmitted response information, by means of the user device communication unit 150.

Further, the user device control unit 120 outputs the received point and/or discount coupon by means of the user device display unit 130 and/or the user device voice output unit 140.

Further, the user device control unit 120 interworks with an application which is installed in advance in the user device 100 to store the received point and discount coupon in the user device storage unit 110.

Further, the user device control unit 120 receives an advertising corresponding to a product for every recommendation type provided from the service providing device 300, by means of the user device communication unit 150. Here, the advertising corresponding to a product for every recommendation type may be an advertising corresponding to one or more products which are selected respectively in the service providing device 300, correspondingly to a customer satisfying food item, an association analysis based food item, and the most popular food item of the store of the advertiser.

Further, the user device control unit 120 outputs the received advertising corresponding to the product for every recommendation type by means of the user device display unit 130 and/or the user device voice output unit 140.

Further, when the advertising corresponding to the product for every recommendation type which is displayed on the user device display unit 130 is selected (or clicked), the user device control unit 120 displays detailed information of the product on the user device display unit 130 and transmits click information according to the selection of the advertising to the service providing device 300 by means of the user device communication unit 150.

Further, when the advertising corresponding to the product for every recommendation type which is displayed on the user device display unit 130 is selected (or clicked), the user device control unit 120 stores (or registers) a discount coupon included in the selected advertising in the user device storage unit 110.

Further, the user device control unit 120 receives the advertising corresponding to the product for every recommendation type by means of the user device communication unit 150, based on an advertising exposure time corresponding to a product for every recommendation type which is recalculated at a ratio of a click through rate, with respect to advertisings having a high click through rate in the service providing device 300.

Further, the user device control unit 120 outputs the received advertising corresponding to the product for every recommendation type according to the advertising exposure time which is recalculated at a ratio of a click through rate, by means of the user device display unit 130 and/or the user device voice output unit 140.

The user device display unit 130 may display various contents such as various menu screens using a user interface and/or graphic user interface stored in the user device storage unit 110, by the control of the user device control unit 120. Here, the contents displayed on the user device display unit 130 may include a menu screen including various texts, image data (including various information data), and data such as icons, list menus, or a combo boxes. Further, the user device display unit 130 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, an approaching gesture of the user such as hovering in addition to the touch gesture of the user may be sensed.

Further, the user device display unit 130 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the user device display unit 130 may be configured as a stereoscopic display unit which displays a stereoscopic image.

A 3D display type such as a stereoscopic type (a glasses type), an auto-stereoscopic type (a glassless type), and a projection type (a holographic type) may be applied to the stereoscopic display unit.

Further, the user device display unit 130 displays the product information, the response information, the evaluation information, the payment information, and the advertising corresponding to a product for every recommendation type, by the control of the user device control unit 120.

The user device voice output unit 140 outputs voice information included in a signal processed by the user device control unit 120. Here, the user device voice output unit 140 may include a receiver, a speaker, a buzzer, and the like.

Further, the user device voice output unit 140 outputs a guidance voice generated by the user device control unit 120.

Further, the user device voice output unit 140 outputs voice information corresponding to the product information, the response information, the evaluation information, the payment information, and the advertising corresponding to a product for every recommendation type, respectively, by the user device control unit 120.

The user device communication unit 150 connects an arbitrary internal component with at least one arbitrary external terminal through a wired/wireless communication network to communicate each other. In this case, the arbitrary external terminal may include the beacon, the POS terminal 200, the service providing device 300, and the advertising terminal 400. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The user device communication unit 150 transmits and receives data in accordance with at least one wireless Internet technique within a range including also Internet techniques which are not described above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Furthermore, the wired communication technique may include power line communication (PLC), USB communication, Ethernet, serial communication, an optical/coaxial cable, or the like.

Further, the user device communication unit 150 may mutually transmit information with any terminal through a universal serial bus (USB).

Further, the user device communication unit 150 transmits and receives the advertising corresponding to the product information, the response information, the evaluation information, the payment information, and the advertising corresponding to a product for every recommendation type, by the control of the user device control unit 120.

Further, the user device 100 may further include an interface unit (not illustrated) which functions as an interface with all external apparatuses which are connected to the user device 100. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating a permission of the user device 100 and may include a user identity module (UIM), a subscriber identity module (SIM), a universal subscriber identity module (USIM), and the like. Further, the device provided with the identification module may be prepared in a smart card form. Accordingly, the identification module may be connected with the user device 100 through the port. Such an interface unit receives data or power from an external device to transmit the received data or power to each component in the user device 100 or transmit the data in the user device 100 to the external device.

Further, the interface unit may be a passage through which the power from a cradle is supplied to the corresponding user device 100 when the user device 100 is connected to an external cradle or a passage through which various command signals input from the cradle by the user is transferred to the corresponding user device 100. Various command signals input from the cradle or the corresponding power may also operate by a signal for recognizing that the user device 100 is accurately installed on the cradle.

Further, the user device 100 may further include an input unit (not illustrated) for receiving a signal according to a button operation of the user or any function selection or receiving a command or a control signal created by an operation such as an operation of touching/scrolling the displayed screen.

The input unit as a means for receiving at least one of a user's command, selection, data, and information may include a plurality of input keys and function keys for receiving figure or text information and setting various functions.

Further, the input unit may use various devices such as a key pad, a dome switch, a touch pad (a pressure resistive type/a contact capacitive type), a touch screen, a jog wheel, a jog switch, a jog shuttle, a mouse, a stylus pen, and a touch pen. Particularly, when the user device display unit 130 is formed in a touch screen form, some or all of the input functions may be performed by the user device display unit 130.

Further, each component unit (or each module) of the user device 100 may be software stored on a memory (or the user device storage unit 110) of the user device 100. The memory may be an internal memory of the user device 100 and may an external memory or other types of storage devices. Further, the memory may be a non-volatile memory. The software stored on the memory may include a command set to allow the user device 100 to perform a specific operation while executing.

The point of sales (POS) terminal 200 communicates with the beacon (not illustrated), the user device 100, the service providing device 300, the advertising terminal 400, and the payment server (not illustrated).

Further, the POS terminal 200 is provided in an arbitrary store.

Further, the POS terminal 200 provides (or transmits) the product information to one or more user devices 100 which are located (or enter) in the store through beacons (not illustrated) equipped respectively in a plurality of locations in the store. Here, the product information includes a product name, a product unique code, a product image, andproduct description information.

Further, the POS terminal 200 receives the order information transmitted from the user device 100 which visits a store equipped with the POS terminal 200. In this case, the POS terminal 200 may receive the order information via a beacon close to the user device 100. Here, the order information includes an ordered product name (or an order menu name/order food name), the order product unique code, an order quantity (or a quantity for every product), the table number, and the identification information of the user device 100. In this case, the identification information of the user device 100 includes a mobile directory number (MDN), a mobile IP, a mobile MAC, a subscriber identify module (Sim) card unique information, and a serial number.

Further, the POS terminal 200 generates evaluation information corresponding to the order information to survey the evaluation on at least one product name included in the order information. Here, the evaluation information includes an evaluation product item, an evaluation product unique code, a scoring item for every evaluation product, and the table number.

Further, the POS terminal 200 transmits the created evaluation information to the user device 100.

Further, the POS terminal 200 receives response information transmitted from the user device 100, in response to the transmitted evaluation information. Here, the response information includes a product name included in at least one product information, a product unique code, a food satisfaction score for every product, the table number, and the identification information of the user device 100.

Further, the POS terminal 200 transmits (or issues) the point and/or discount coupon which is set in advance in the user device 100 which transmits the response information.

Further, the POS terminal 200 performs the payment function on a payment amount corresponding to the order information by interworking with the user device 100 and the payment server (not illustrated). In this case, a discount function may be applied to a part of the payment amount by applying a discount coupon which is stored (or registered) in advance in the user device 100.

Further, the POS terminal 200 provides the payment function performed result (or payment information) to the user device 100, the service providing device 300, the payment server, and the like. Here, the payment information includes a store name, a store location, a store contact number, order information, a payment data, and time information, and price information for every order product.

Further, the POS terminal 200 transmits the response information, the payment information, and the store information (or identification information of the POS terminal 200 corresponding to the store information) to the service providing device 300. Here, the response information includes at least one product name, a product unique code, a food satisfaction score for every product, the table number, the identification information of the user device 100, and the like.

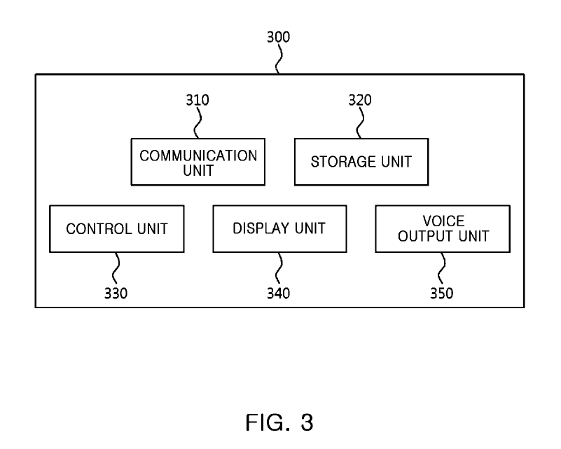

As illustrated in FIG. 3, the service providing device 300 is constituted by a communication unit 310, a storage unit 320, a control unit 330, a display unit 340, and a voice output unit 350. All the constituent elements of the service providing device 300 illustrated in FIG. 3 are not essential constituent elements, and the service providing device 300 may be implemented by more constituent elements than the constituent elements illustrated in FIG. 3 or less constituent elements therethan.

The communication unit 310 communicates with any internal constituent element or at least one arbitrary external terminal via a wired/wireless communication network. In this case, the arbitrary external terminal may include the user device 100, the POS terminal 200, and the advertising terminal 400. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS) The terminal communication unit 150 transmits and receives data in accordance with at least one wireless Internet technique within a range including Internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Further, the wired communication technique may include power line communication (PLC), USB communication, Ethernet, serial communication, optical/coaxial cable, or the like.

Further, the communication unit 310 may exchange information with any terminal through a universal serial bus (USB).

Further, the communication unit 310 receives the response information, the payment information, and the store information (or the identification information of the POS terminal 200 corresponding to the store information) which are transmitted from the POS terminal 200, by the control of the control unit 330. Here, the response information includes at least one product name, a product unique code, a food satisfaction score for every product, the table number, the identification information of the user device 100, and the like.

The storage unit 320 stores various user interfaces UI and graphic user interfaces GUI.

Further, the storage unit 320 stores data and programs required to operate the service providing device 300.

That is, the storage unit 320 may store a plurality of application programs which are driven in the service providing device 300 and data and commands for operation of the service providing device 300. At least some of the application programs may be downloaded from an external server through wireless communication. In the meantime, the application program is stored in the storage unit 320 and installed on the service providing device 300 to be driven to perform an operation (or a function) of the service providing device 300 by the control unit 330.

Further, the storage unit 320 may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the service providing device 300 may operate a web storage which performs a storing function of the storage unit 320 on the Internet or operate in association with the web storage.

Further, the storage unit 320 stores the response information, the payment information, and the store information (or the identification information of the POS terminal 200 corresponding to the store information) which are received through the communication unit 310, by the control of the control unit 330.

The control unit 330 performs an overall control function of the service providing device 300.

Further, the control unit 330 performs an overall control function of the service providing device 300 using a program and data stored in the storage unit 320. The control unit 330 may include a RAM, a ROM, a CPU, a GPU, and a bus, and the RAM, the ROM, the CPU, the GPU, and the like may be connected to each other through the bus. The CPU accesses the storage unit 320 to perform booting using an O/S stored in the storage unit 320 and performs various operations using various programs, contents, and data stored in the storage unit 320.

Further, the control unit 330 performs a member joining procedure for a user of the user device 100 and a user of the advertising terminal 400 by interworking with the user device 100 and the advertising terminal 400, respectively.

Further, the control unit 330 controls the communication unit 310 to receive the response information, the payment information, and the store information (or the identification information of the POS terminal 200 corresponding to the store information) which are transmitted from the POS terminal 200.

Further, the control unit 330 respectively selects (or confirms/recommends) one or more products (or foods) for every recommendation type, based on the received response information, payment information, store information, and information related to a store equipped with the POS terminal 200 which is stored in advance in the storage unit 320. Here, the information related to the store equipped with the POS terminal 200 includes total payment amount information which is paid in the store for a predetermined time, an order quantity (or a number of users for every product) for one or more products (or menus/foods) provided in the store, an entire food price paid at every date in the store, and order information/payment information for every terminal which makes a payment in the store. Further, the recommendation type includes a customer satisfying food item, an association analysis based food item, and the most popular food item of the store of the advertiser.

That is, the control unit 330 calculates a personal food satisfaction score (or personal food satisfaction score for every product/every food/every menu) corresponding to the customer satisfying food item as represented in the following Equation 1, based on the food satisfaction score for every product included in the response information, payment date and time information included in the payment information, price information for every order product, and the entire food price paid at every date which is stored in advance.

Personal food satisfaction score=^{Sum of period}Σ{1/(Today's date−Store visit date)×food satisfaction score}+(ΣPrice of food purchased by customer/Entire food price at store visit date) [Equation 1]

Here, the sum of periods indicates a predetermined period (for example, seven days ago from today). The today's date and the store visit date are represented by values which are converted into the unit of seconds with respect to a predetermined reference time. The entire food price on the store visit day indicates a total amount of the entire food prices which are paid in the store on that day when the terminal 300 corresponding to the control unit 330 makes the payment in the store (or the entire food price corresponding to the payment date when the user makes a payment among the entire food prices which are paid in the store at every date). The price of the food which is purchased by the customer indicates a price of the specific product (or food/menu) ordered by the user. The today's date may be a time when the personal food satisfaction score is calculated (or a current time).

As described above, the control unit 330 applies a time weight to latest data of the food which has a good taste evaluation from the customer within a specific period (for example, a weight point is applied to the evaluation for a food which is recently eaten) and a weight is applied to more expensive food (or menu) among the foods of the advertiser (or menus sold in the store) to calculate a personal food satisfaction score.

Further, the control unit 330 checks (or extracts) at least one personal food satisfaction score corresponding to a predetermined number of higher personal food satisfaction scores among a plurality of personal food satisfaction scores which is calculated for every user.

Further, the control unit 330 respectively checks a product name corresponding to the checked at least one personal food satisfaction score.

Further, the control unit 330 selects the checked product name (or a product name corresponding to the checked at least one personal food satisfaction score) as a customer satisfying product (or a customer satisfying food).

Further, the control unit 330 stores the selected customer satisfying product (or the customer satisfying food) in the storage unit 320.

Further, the control unit 330 checks (or selects) an association analysis based recommended product (or food) corresponding to the association analysis based food item, based on the previously calculated personal food satisfaction score (or the personal food satisfaction score for every product) and the personal food satisfaction score calculated for the product name ordered by another user device which is stored in advance. In this case, there may be many foods or products, so that the control unit 330 may filter some of many products (or foods) using co-occurrence indicating how many people simultaneously eat the food (or order the product/or make a payment for the product) and performs the association analysis on the filtered product (or food).

That is, the control unit 330 calculates an Euclid distance based similarity (or one-dimensional Euclid distance based similarity) through a similarity algorithm based on the previously calculated personal food satisfaction score (or a personal food satisfaction score for every product/every food/every menu) and the personal food satisfaction score calculated for the product ordered by another user device, as represented in the following Equation 2. In this case, the control unit 330 calculates (or measures) the similarity only with a distance (for example, a deviation of absolute values) of the personal food satisfaction scores for the same product for every user.

Euclid distance based similarity=1/(1+|Personal satisfaction score of food A−Personal satisfaction score of food B|) [Equation 2]

Here, a personal satisfaction score of food A indicates a personal food satisfaction score for every product calculated based on the response information and the payment information transmitted from the user device 100 and a personal satisfaction score of food B indicates a personal food satisfaction score for every product calculated based on the response information and the payment information transmitted from another user device which has a similar taste to the user of the user device 100.

Further, the control unit 330 calculates a total score for every user based on the calculated Euclid distance based similarity for the plurality of products to represent the similarity of the tastes between users as a numerical value.

Further, the control unit 330 checks at least one user (or a user having a similar taste) corresponding to a predetermined number of higher total scores among the calculated total score for every user.

Further, the control unit 330 selects (or generates) a product which is not ordered by the user device 100 (or a product/menu/food which is not eaten by the user of the user device 100), among the plurality of products ordered by at least one user, based on the payment information paid by the checked at least one user (or a user having the similar taste), as the association analysis based recommended product (or the association analysis based recommended food).

Further, the control unit 330 stores the selected association analysis based recommended product (or the association analysis based recommended food) in the storage unit 320.

Further, the control unit 330 calculates a customer satisfaction score for every food corresponding to the most popular food item of the store of the advertiser, as represented in the following Equation 3, based on the personal food satisfaction score (or personal food satisfaction score for every product/every food/every menu) calculated for the user device 100, the personal food satisfaction score calculated for the product name ordered by another user device which is stored in advance, the click through rate (CTR) for every product, and a number of times of downloading a coupon for every product.

Customer satisfaction score for every food=(^{all users}Σ Personal food satisfaction score)×(CTR for every food×Number of times of downloading coupon) [Equation 3]

Further, the control unit 330 checks at least one customer satisfaction score for every product corresponding to another predetermined number of the highest customer satisfaction scores for every food among the calculated customer satisfaction score for every food.

Further, the control unit 330 selects (or generates) at least one product (or food) corresponding to the checked at least one customer satisfaction score for every product as the most popular product (or food) of the store of the advertiser.

Further, the control unit 330 stores the selected most popular product (or the food) of the store of the advertiser in the storage unit 320.

Further, the control unit 330 calculates an advertising exposing time of an advertising corresponding to a product for every recommendation type.

That is, the control unit 330 applies the same advertising exposing time for every recommendation type at first.

Further, the control unit 330 provides the advertising corresponding to the product for every recommendation type according to the initially applied same advertising exposing time to one or more user devices 100.

Further, when the advertising is provided for a predetermined time (for example, including one hour or one day) or longer, the control unit 330 calculates an advertising impression (or an advertising impression for every recommendation type) corresponding to the product for every recommendation type based on a click through rate of an advertising corresponding to the product for every recommendation type, a click through rate of an advertising corresponding to the entire products of every recommendation type, and the entire impressions of the advertising corresponding to the product for every recommendation type, as represented in the following Equation 4.

Advertising impression for every recommendation type=Floor (CTR for every recommendation type/ΣCTR of recommendation type×entire impressions) [Equation 4]

Here, a Floor operator indicates an operator which truncates values below the decimal point and the click through rate (CTR) is represented by number of clicks/number of impressions×100.

Further, the control unit 330 provides an advertising corresponding to the product for every recommendation type according to the previously calculated advertising impression for every recommendation type among the total exposure time of the entire advertising based on the total exposure time of the entire advertising and the previously calculated advertising impression for every recommendation type to one or more user devices 100 through the communication unit 310.

Further, the control unit 330 recalculates the advertising impressions corresponding to the product for every recommendation type by Equation 4 based on the click through rate of the advertising corresponding to the product for every recommendation type from the plurality of user devices 100, the click through rate of the advertising corresponding to the entire products for every recommendation type, and the entire impressions of the advertising corresponding to the product for every recommendation type.

As described above, the control unit 330 may recalculates the previously selected advertising exposure time for the product for every recommendation type at a ratio of the click through rate, with respect to the advertising having a high click through rate.

Further, the control unit 330 provides an advertising corresponding to the product for every recommendation type to another one or more user devices 100 through the communication unit 310, based on the recalculated advertising exposure time corresponding to the product for every recommendation type.

Further, the control unit 330 interworks with the advertising terminal 400 at every predetermined period (for example, including one day, one week, or one month) to performs an advertising cost calculating function.

In this case, the control unit 330 and the advertising terminal 400 calculate the advertising cost corresponding to the number of used coupons according to the number of actually used coupons in the user device 100.

The display unit 340 may display various contents such as various menu screens using a user interface and/or graphic user interface stored in the storage unit 320, by the control of the control unit 330. Here, the contents displayed on the display unit 340 may include a menu screen including various texts, image data (including various information data), and data such as icons, list menus, or a combo boxes. Further, the display unit 340 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, not only the touch gesture of the user, but also approaching gesture of the user, such as hovering may be detected.

Further, the display unit 340 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the display unit 340 displays the response information, the payment information, and the store information by the control of the control unit 330.

The voice output unit 350 outputs voice information included in a signal-processed signal by the control unit 330. Here, the voice output unit 350 may include a receiver, a speaker, a buzzer, and the like.

Further, the voice output unit 350 outputs a guidance voice generated by the control unit 330.

Further, the voice output unit 350 outputs voice information corresponding to the response information, the payment information, and the store information respectively by the control of the control unit 330.

Further, the service providing device 300 may be implemented in a form such as a web server, a database server, and a proxy server. Further, in the service providing device 300, one or more of various software which allows a network load distribution mechanism or a service providing device 300 to operate on the Internet or other networks may be installed, and as a result, the service providing device 300 may be implemented by a computerized system. Further, the network may be an http network and may be a private line, Intranet, or any other networks. Furthermore, the service providing device 300 and the user device 100 or the advertising terminal 400 may be connected to each other by a security network so as to suppress the data from being attacked by any hacker or other third parties. Further, the service providing device 300 may include a plurality of database servers. The database server may be implemented to be separately connected with the service providing device 300 through any type of network connection including a distributed database server architecture.

Further, a processor mounted in the user device 100, the advertising terminal 400 or the service providing device 300 according to the embodiment of the present invention may process the program command to execute the method according to the exemplary embodiment of the present invention. In an implemented embodiment, the processor may be a single-threaded processor. In another implemented embodiment, the processor may be a multi-threaded processor. Further, the processor may process the command stored on the memory or the storage device.

The advertising terminal 400 interlocks with the service providing device 300 to perform a member joining procedure for the user of the advertising terminal 400.

Further, when the member joining procedure is performed, the member joining procedure for the service providing device 300 may be normally completed only by completing the authentication function through a self-authentication unit (for example, including a mobile phone, a credit card, I-PIN, e-mail, and the like).

Further, the advertising terminal 400 may be a terminal related to an owner or a keeper of a store equipped with the POS terminal 200.

Further, the advertising terminal 400 communicates with the user device 100, the POS terminal 200, the service providing device 300, and the like.

Further, the advertising terminal 400 generates (or creates) advertisings (or advertising contents) for one or more products which are provided (or sold) in the store by an advertising copywriter and stores the generated one or more advertisings.

Further, the advertising terminal 400 provides (or transmits) advertiser product information and the identification information of the advertising terminal 400 which are provided by the advertiser who is a user of the advertising terminal 400 to the service providing device 300. Here, the advertiser product information includes a product unique code, a product name, a product image, and product description information.

Further, the advertising terminal 400 interworks with the service providing device 300 at every predetermined period (for example, including one day, one week, or one month) to performs an advertising cost calculating function.

In this case, the service providing device 300 and the advertising terminal 400 calculates the advertising cost corresponding to the number of used coupons according to the number of coupons which are actually used in the user device 100.

As described above, an advertising targeting set which is personalized based on a food list and payment information which are provided after having a mean in the store of the advertiser is extracted and then the extracted advertising targeting is provided to the terminal corresponding to the payment information.

Further, as described above, a retargeting platform in an online to offline or offline to online (O2O) market may be constituted to provide the product to the store of the advertiser as an advertising, collect the feedback of the customer, and the provide the coupon.

Hereinbelow, a control method of a retargeting advertising product recommending system according to an embodiment of the present invention will be described in detail with reference to FIGS. 1 to 7.

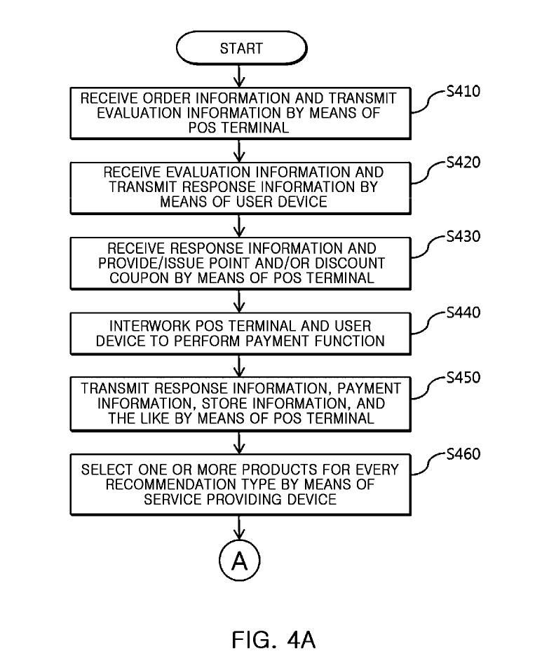

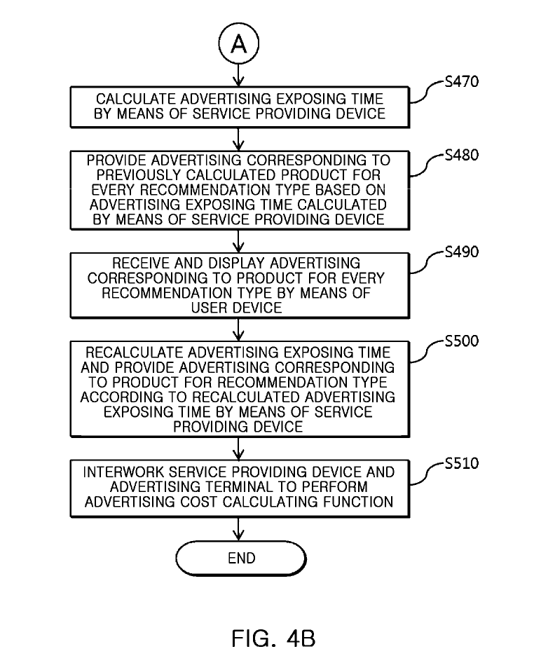

FIGS. 4A and 4B are flowcharts illustrating a control method of a retargeting advertising product recommending system according to an embodiment of the present invention.

First, the POS terminal 200 receives the order information transmitted from the user device 100 which visits a store equipped with the POS terminal 200. Here, the order information includes an ordered product name (or an order menu name/order food name), the order product unique code, an order quantity (or a quantity for every product), the table number, and the identification information of the user device 100. In this case, the identification information of the user device 100 includes a mobile directory number (MDN), a mobile IP, a mobile MAC, a subscriber identify module (Sim) card unique information, and a serial number.

Further, the POS terminal 200 transmits evaluation information corresponding to the order information to the user device 100. Here, the evaluation information includes an evaluation product item, an evaluation product unique code, a scoring item for every evaluation product, and the table number.

That is, the user device 100 receives one or more product information, a table number, and the like which are transmitted from a beacon (not illustrated) adjacent to (or disposed/provided on) a table in a store and are provided from the store. Here, the product information includes a product name, a product unique code, a product image, and product description information. Further, the user device 100 displays one or more product information and the table number which are previously received, through an application which is installed in advance in the user device 100. Further, at least one product information is selected from the one or more product information displayed on the user device 100 and a quantity (or a quantity for every product) corresponding to the selected at least one product information is selected. Thereafter, the user device 100 transmits order information including a product name (or an ordered product name) included in the selected at least one product information, the product unique code (or the ordered product unique code), an order quantity, a table number, and identification information of the user device 100 to the POS terminal 200 through the beacon. Further, the POS terminal 200 transmits the evaluation information including an evaluation product item corresponding to at least one product information, an evaluation product unique code item, a scoring item for every evaluation product, and the table number to the user device 100 through the beacon to survey evaluation for at least one product name included in the order information.

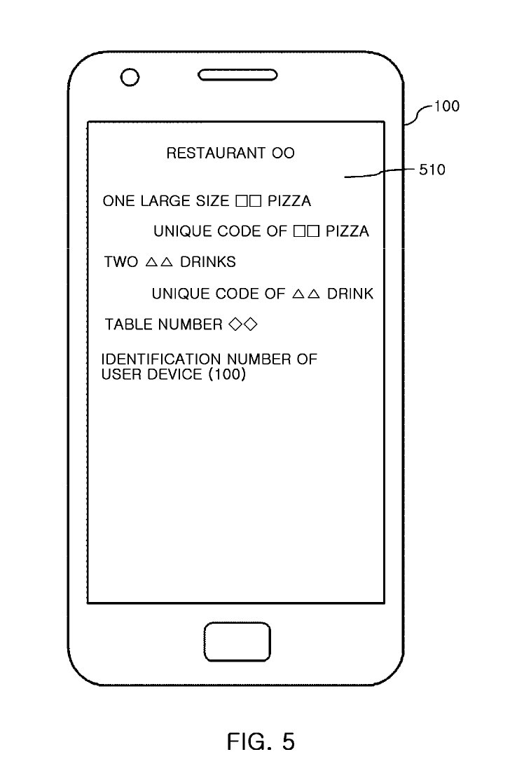

For example, as illustrated in FIG. 5, the user device 100 transmits one large size pizza B, and two drinks C selected from one or more product information, an unique code of pizza B, an unique code of drink C, and a table number 1, and the identification information 510 of the user device 100 which are transmitted from a beacon close to the table number 1 of a restaurant A, to the POS terminal 200. Further, the POS terminal 200 transmits the evaluation information including an evaluation product item including the pizza B and the drink C, the unique code of the evaluation product, and the scoring item for every evaluation product (for example, which is increased by one point between one point and ten points) to the user device 100 (S410).

Next, the user device 100 receives the evaluation information transmitted from the POS terminal 200 in response to the previously transmitted order information.

Further, the user device 100 transmits the response information to the POS terminal 200 in response to the received evaluation information. Here, the response information includes a product name included in at least one product information, a product unique code, a food satisfaction score for every product, the table number, and the identification information of the user device 100.

That is, the user device 100 transmits an evaluation product item included in the received evaluation information, a food satisfaction score for every product in accordance with a user input for the scoring item for every evaluation product, at least one product name corresponding to the evaluation product item, the product unique code, the table number, and the identification information of the user device 100 to the POS terminal 200 via the beacon.

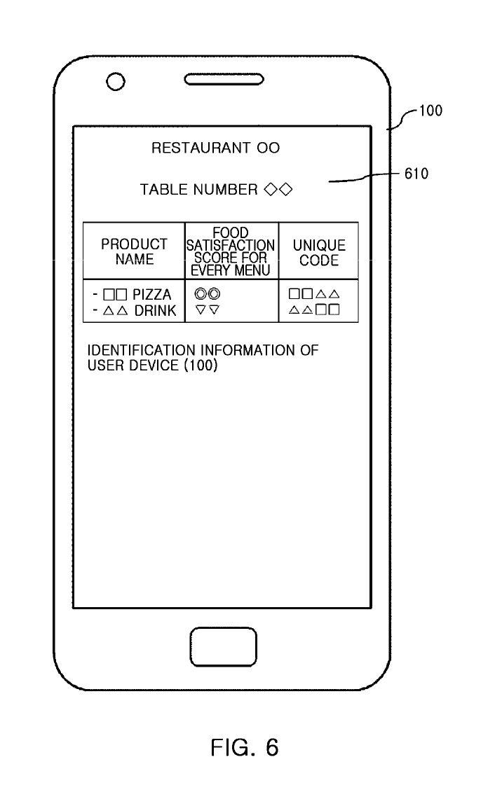

For example, as illustrated in FIG. 6, the user device 100 transmits the response information 610 including an evaluation product item including the pizza B and the drink C, a food satisfaction score for every menu including five points which are the food satisfaction score for the pizza B and three points which are the food satisfaction score for the drink C in accordance with the user input for the scoring item (for example, which is increased by one point between one point and ten points) for every evaluation product, at least one product name including the pizza B and the drink C, the unique code for every product, the table number 1, and the identification information of the user device 100 to the POS terminal 200 through the beacon (S420).

Thereafter, the POS terminal 200 receives response information transmitted from the user device 100, in response to the transmitted evaluation information.

Further, the POS terminal 200 transmits (or issues) the point and/or discount coupon which is set in advance in the user device 100 which transmits the response information.

Further, the user device 100 receives the points and/or the discount coupon which are transmitted (or issued/provided) from the POS terminal 200 in response to the transmitted response information and stores and displays the received points and/or discount coupon through the application which is installed in advance in the user device 100.

For example, the POS terminal 200 receives response information including a food satisfaction score for every product including five points which are the food satisfaction score for the pizza B and three points which are the food satisfaction score for the drink C, at least one product name including the pizza B and the drink C, the unique code for every product, the table number 1, and the identification information of the user device 100 which are transmitted from the user device 100 in response to the transmitted evaluation information and displays the received response information. Further, the POS terminal 200 issues a discount coupon (for example, including 10% discount coupon of the restaurant A) which is registered in advance in the user device 100 which transmits the response information (S430).

Next, the POS terminal 200 performs a payment function on a payment amount corresponding to the order information by interworking with the user device 100 and the payment server (not illustrated). In this case, a discount function may be applied to a part of the payment amount by applying a discount coupon which is stored (or registered) in advance in the user device 100.

Further, the POS terminal 200 provides the payment function performed result (or payment information) to the user device 100. Here, the payment information includes a store name, a store location, a store contact number, order information, a payment data, and time information, and price information for every order product.

For example, after eating the pizza B and the drink C which are products (or foods) provided to the user of the user device 100 in response to the order information in the store where the POS terminal 200 is located, the POS terminal 200 interworks the payment server of the user device 100 to perform the payment function and provides a payment function performing result to the user device 100. Further, the user device 100 displays and stores the payment function performing result through a dedicated application (S440).

Next, the POS terminal 200 transmits the response information, the payment information, and the store information (or identification information of the POS terminal 200 corresponding to the store information) to the service providing device 300. Here, the response information includes at least one product name, a product unique code, a food satisfaction score for every product, the table number, and the identification information of the user device 100. Further, the payment information includes a store name, a store location, a store contact number, order information, a payment data, and time information, and price information for every order product.

For example, the POS terminal 200 transmits the response information, the payment information, and store information to the service providing device 300. In this case, the response information includes the food satisfaction score for every menu including five points which are the food satisfaction score for the pizza B and three points which are the food satisfaction score for the drink C, at least one product name including the pizza B and the drink C, the unique code for every product, the table number 1, and the identification information of the user device 100 (S450).

Next, the service providing device 300 receives the response information, the payment information, and the store information (or identification information of the POS terminal 200 corresponding to the store information) which are transmitted from the POS terminal 200.

Further, the service providing device 300 respectively selects (or confirms/recommends) one or more products (or foods) for every recommendation type, based on the received response information, payment information, store information, and in formation related to a store equipped with the POS terminal 200 which is stored in advance in the service providing device 300. Here, the information related to the store equipped with the POS terminal 200 includes total payment amount information which is paid in the store for a predetermined time, an order quantity (or a number of users for every product) for one or more every product (or every menu/every food) provided in the store, an entire food price paid at every date in the store, and order information/payment information for every terminal which makes a payment in the store. Further, the recommendation type includes a customer satisfying food item, an association analysis based food item, and the most popular food item of the store of the advertiser.

That is, the service providing device 300 calculates a personal food satisfaction score (or personal food satisfaction score for every product/every food/every menu) corresponding to the customer satisfying food item as represented in Equation 1, based on the food satisfaction score for every product included in the response information, payment date and time information included in the payment information, price information for every order product, and the entire food price paid at every date in the store which is stored in advance.

As described above, the service providing device 300 applies a time weight to latest data of the food which has a good taste evaluation from the customer within a specific period (for example, a weighted point is applied to the evaluation for a food which is recently eaten) and a weight is applied to more expensive food (or menu) among the foods of the advertiser (or menus sold in the store) to calculate a score of personal food satisfaction.

Further, the service providing device 300 checks (or extracts) at leastonepersonalfoodsatisfactionscorecorrespondingtoapredetermined number of higher personal food satisfaction scores among a plurality of personal food satisfaction scores which is calculated for every user.

Further, the service providing device 300 respectively checks a product name corresponding to the checked at least one personal food satisfaction score.

Further, the service providing device 300 selects the checked product name (or a product name corresponding to the checked at least one personal food satisfaction score) as a customer satisfying product (or a customer satisfying food).

For example, the service providing device 300 calculates the personal food satisfaction score for every product which is paid by a user (for example, a user A) of the user device 100 who visits the restaurant A, as represented in the following Table 1.

TABLE 1

| | | | | Food | Personal |
|---|---|---|---|---|---|
| | | | | satis- | food |
| User | Food | Store visit | Price | faction | satisfaction |
| (Customer) | ID | date | of food | score | score |
| A | 1 | 2015 Feb. 10 | 5,000 | 5 | 0.03 |
| A | 2 | 2015 Feb. 10 | 10,000 | 2 | 0.01 |
| A | 5 | 2014 Dec. 11 | 3,000 | 1 | 0.0011 |
| A | 8 | 2015 Jan. 5 | 7,000 | 5 | 0.012 |

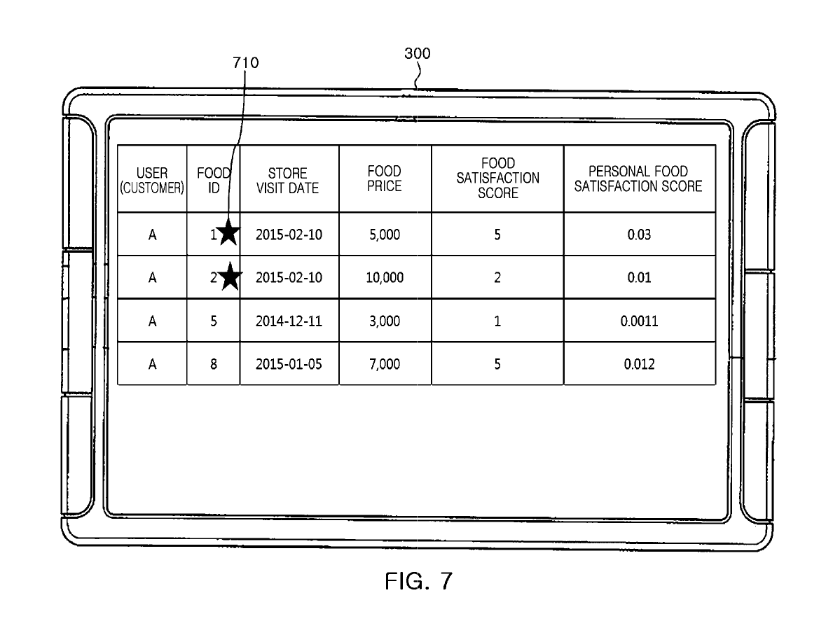

Further, as illustrated in FIG. 7, the service providing device 300 checks a food ID 1 and a food ID 2 corresponding to two which is a predetermined number of higher personal food satisfaction scores (or in the order of personal food satisfaction scores) among personal food satisfaction scores for every product calculated as represented in Table 1 and adds marks 710 to the checked food ID 1 and food ID 2.

Further, the service providing device 300 respectively checks the product names corresponding to the checked food ID 1 and the checked food ID 2.

Further, the service providing device 300 checks (or selects) an association analysis based recommended product (or food) corresponding to the association analysis based food item, based on the previously calculated personal food satisfaction score (or the personal food satisfaction score for every product) and the personal food satisfaction score calculated for the product name ordered by another user device which is stored in advance. In this case, there may be many foods or products, so that the service providing device 300 may filter some of many products (or foods) using co-occurrence indicating how many people simultaneously eat (or order the product/or make a payment for the product) and performs the association analysis on the filtered product (or food).

That is, the service providing device 300 calculates an Euclid distance based similarity (or one-dimensional Euclid distance based similarity) through a similarity algorithm based on the previously calculated personal food satisfaction score (or a personal food satisfaction score for every product/every food/every menu) and the personal food satisfaction score calculated for the product ordered by another user device, as represented in Equation 2. In this case, the service providing device 300 calculates (or measures) the similarity only with a distance (for example, a deviation of absolute values) of the personal food satisfaction scores for the same product for every user.

Further, the service providing device 300 calculates a total score for every user based on the calculated Euclid distance based similarity for the plurality of products to represent the similarity of the tastes between users as a numerical value.

Further, the service providing device 300 checks at least one user (or a user having a similar taste) corresponding to another predetermined number of higher total scores among the calculated total scores for every user.

Further, the service providing device 300 selects (or generates) a product which is not ordered by the user device 100 (or a product/menu/food which is not eaten by the user device 100), among the plurality of products ordered by at least one user, based on the payment information paid by the checked at least one user (or a user having the similar taste), as the association analysis based recommended product (or the association analysis based recommended food).

As another example, the service providing device 300 may configure only foods which are simultaneously eaten by fifty person or more and set in advance as represented in the following Table 2, as recommendation target foods.

TABLE 2

| | Number of unique users |
|---|---|
| Food 1 | 200 |
| Food 2 | 170 |
| Food 3 | 160 |
| Food 4 | 155 |

Further, the service providing device 300 respectively calculates the Euclid distance based similarity through Equation 2 based on the previously calculated personal food satisfaction score (or a personal food satisfaction score for every product/every food/every menu) for the user A related to the user device 100 and the personal food satisfaction scores for the user B and the user C which are stored in advance as represented in Table 3. Here, in the Euclid distance based similarity, when the similarity is close to 1, the similarity is high.

TABLE 3

| | Food 1 | | |
|---|---|---|---|
| | of user A | Food 2 of user A | Food 3 of user A |
| Food 1 of user A | 1 | | |
| Food 2 of user A | | 1 | |
| Food 3 of user A | | | 1 |
| Food 1 of user B | 0.2 | | |
| Food 2 of user B | | 0.7 | |
| Food 3 of user B | | | 0.8 |
| Food 4 of user B | | | |
| Food 3 of user C | | | 0.7 |
| Food 4 of user C | | | |

Further, the service providing device 300 calculates a total similarity for every user based on the calculated Euclid distance based similarity for the foods to represent the similarity of the tastes between users as a numerical value.

TABLE 4

| | User A |
|---|---|
| User A | 3 |
| User B | 1.7 |
| User C | 0.7 |

Further, the service providing device 300 checks the user B and the user C corresponding to two (or two users) which are a predetermined number of higher total scores among the calculated total scores for every user.

Further, the service providing device 300 checks a product (for example, the food 4 of the user B and the food 4 of the user C) which is not ordered by the user A of the user device 100, among the plurality of products (for example, foods 1 to 4) which is paid by the user B and the plurality of products (for example, foods 3 and 4) which is paid by the user C and selects (or generates) the checked product (for example, the food 4) which is not ordered in the user device 100, among the plurality of products which is paid by the user B and the plurality of products which is paid by the user C as an association analysis based recommendation food.

As described above, the service providing device 300 may allow the users to recommend a food which is not eaten by the other users having a similar food taste through the similarity measurement based association analysis.

Further, the service providing device 300 calculates a customer satisfaction score for every food corresponding to the most popular food item of the store of the advertiser, as represented in Equation 3, based on the personal food satisfaction score (or personal food satisfaction score for every product/every food/every menu) calculated for the user device 100, the personal food satisfaction score calculated for the product name ordered by another user device which is stored in advance, the click through rate (CTR) for every product, and a number of times of downloading a coupon for every product.

Further, the service providing device 300 checks at least one customer satisfaction score for every product corresponding to another predetermined number of the highest customer satisfaction score for every food among the calculated customer satisfaction scores for every food.

Further, the service providing device 300 selects (or generates) at least one product (or food) corresponding to the checked at least one customer satisfaction score for every product as the most popular product (or food) of the store of the advertiser.

As another example, the service providing device 300 calculates a customer satisfaction score for every food for the food 1, the food 2, the food 3, and the food 4, by Equation 3.

Further, the service providing device 300 checks the food 3 corresponding to one which is a predetermined number of the highest score among the calculated customer satisfaction scores for every food.

Further, the service providing device 300 selects the checked food 3 as the most popular food of the store of the advertiser (S460).

Thereafter, the service providing device 300 calculates an advertising exposing time of an advertising corresponding to the selected product for every recommendation type.

That is, the service providing device 300 applies the same advertising exposure time for every recommendation type at first and then calculates an advertising impression (or an advertising impression for every recommendation type) corresponding to the product for every recommendation type based on a click through rate of an advertising corresponding to the product for every recommendation type, a click through rate of an advertising corresponding to the entire products of every recommendation type, and the entire impressions of the advertising corresponding to the product for every recommendation type, as represented in Equation 4.

For example, when the click through rates (CTR) for the customer satisfaction food item, the association analysis based food item, and the most popular food item of the store of the advertiser are calculated to be 5%, 2%, and 3% as represented in Table 5, if total ten advertisings (or advertising products) need to be prepared, the service providing device 300 adjusts advertisings for the customer satisfying food item to be five, advertisings for the association analysis based food item to be two, and advertisings for the most popular food item in the store of the advertiser to be three.

TABLE 5

| | | | | Advertising |
|---|---|---|---|---|
| Recommendation | | | | impression for every |
| type | Impression | Click | CTR | recommendation type |
| Customer satisfying | 1000 | 50 | 5% | 1500 |
| food | | | | |
| Association | 1000 | 20 | 2% | 600 |
| analysis based food | | | | |
| Most popular food | 1000 | 30 | 3% | 900 |
| in store | | | | |

As described above, the service providing device 300 determines that an advertising effect of an advertising which has a high click count so that the click through rate is changed is good and adjusts an exposure frequency of the advertising (S470).

Next, the service providing device 300 provides an advertising corresponding to the product for every recommendation type according to the previously calculated advertising impressions for every recommendation type among the total exposure time of the entire advertising and based on the total exposure time of the entire advertising and the previously calculated advertising impressions for every recommendation type, to one or more user devices 100.

For example, the service providing device 300 provides advertisings which are adjusted to be five advertisings for the customer satisfying food item, two advertisings for the association analysis based food item, and three advertisings for the most popular food of the store of the advertiser to one or more user devices 100 in accordance with the advertising impressions for every recommendation type (for example, including 1500 times for the customer satisfying food item, 600 times for the association analysis based food item, and 900 times for the most popular food item of the store of the advertiser) (S480).

Next, the user device 100 receives the advertising corresponding to the product for every recommendation type which is provided from the service providing device 300.

Further, the user device 100 displays the received advertising corresponding to the product for every recommendation type.

Further, when the advertising corresponding to the product for every recommendation type which is displayed on the user device 100 is selected (or clicked), the user device 100 displays detailed information of the product and transmits click information according to the selection of the advertising to the service providing device 300.

Further, when the advertising corresponding to the product for every recommendation type which is displayed on the user device 100 is selected (or clicked), the user device 100 stores (or registers) a discount coupon included in the selected advertising in the user device 100.

For example, the user device 100 outputs an advertising corresponding to the food 4 which is selected in the association analysis based food item provided from the service providing device 300 (S490).

Next, the service providing device 300 recalculates the advertising impressions corresponding to the product for every recommendation type by Equation 4 based on the click through rate of the advertising corresponding to the product for every recommendation type from the plurality of user devices 100, the click through rate of the advertising corresponding to the entire products for every recommendation type, and the entire impressions of the advertising corresponding to the product for every recommendation type.

As described above, the service providing device 300 recalculates the advertising exposing time for the product for every recommendation type which is previously selected at a ratio of a click through rate, with respect to advertisings having a high click through rate and provides the advertising corresponding to the product for every recommendation type based on the recalculated advertising exposing time for the product for every recommendation type to the one or more user devices 100.

Further, another one or more user devices 100 may receive and display the advertising corresponding to the product for every recommendation type provided from the service providing device 300 based on the recalculated advertising exposing time (S500).

Next, the service providing device 300 interworks with the advertising terminal 400 to perform the advertising cost calculating function at every predetermined period.

In this case, the service providing device 300 and the advertising terminal 400 may calculate the advertising cost corresponding to the number of used coupons according to the number of coupons which are actually used in the user device 100 (S510).

The retargeting advertising product recommending user device and service providing device, and the advertising product recommending system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the user device, the POS terminal, the service providing device, the advertising terminal, and the like according to the embodiment of the present invention to implement the retargeting advertising product recommending user device, service providing device, and the advertising product recommending system including the same.

The non-transitory computer readable storage medium includes a magnetic storage medium, an optical storage medium, and a carrier wave medium. A computer program implementing the retargeting advertising product recommending user device, the service providing device, and the advertising product recommending system including the same according to the embodiment of the present invention may be stored and installed in embedded memories of the user device, the POS terminal, the service providing device, the advertising terminal, and the like. Alternately, an external memory such as a smart card storing and installing the computer program implementing the retargeting advertising product recommending user device, the service providing device, and the advertising product recommending system including the same according to the embodiment of the present invention may be installed in the user device, the POS terminal, the service providing device, the advertising terminal, and the like through an interface.

According to the embodiment of the present invention, as described above, it is possible to extract an advertising targeting set personalized based on a food list and payment information provided after having a meal at a store of an advertiser and provide the extracted advertising targeting to a terminal corresponding to the corresponding payment information, thereby inducing the user of the terminal to revisit the restaurant and calculating an advertising cost only for a food ordered through the advertising to reasonably set the advertising cost.

Further, according to the embodiment of the present invention, as described above, a retargeting platform in an online to offline or offline to online (020) market may be constituted to provide the product to the store of the advertiser as an advertising, collect the feedback of the customer, and the provide the coupon, thereby maximizing an advertising effect and increasing satisfaction of the user.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

### INDUSTRIAL APPLICABILITY

According to the present invention, it is possible to extract an advertising targeting set personalized based on a food list and payment information provided after having a meal at a store of an advertiser and provide the extracted advertising targeting to a terminal corresponding to the corresponding payment information, thereby inducing the user of the terminal to revisit the restaurant and calculating an advertising cost only for a food ordered through the advertising to reasonably set the advertising cost.

1. A service providing device, comprising:
a storage unit which stores information related to a store equipped with a POS terminal including total payment amount information which is paid through the store equipped with the POS terminal for a predetermined period, a number of one or more ordered products provided from the store, an entire food price paid at every date in the store, and order information or payment information for every terminal which makes a payment in the store;
a communication unit which receives response information, payment information, and store information which are transmitted from the POS terminal and generated by a user device; and
a control unit which selects a customer satisfying food item, an association analysis based food item, and the most popular food item of a store of an advertiser based on the received response information, payment information, and store information and information related to the store equipped with the POS terminal which is stored in advance in the storage unit, calculates an advertising exposing time of an advertising corresponding to the selected product for every recommendation type, and controls the communication unit to provide the advertising corresponding to the selected product for every recommendation type according to the calculated advertising exposing time to one or more user devices.

2. The service providing device of claim 1, wherein the control unit calculates a personal food satisfaction score for every product corresponding to the customer satisfying food item based on the food satisfaction score for every product included in the response information, payment date and time information included in the payment information, price information for every order product included in the payment information, and the entire food price paid at every date in the store which is stored in the storage unit, checks at least one personal food satisfaction score corresponding to a predetermined number of higher personal food satisfaction scores among a plurality of personal food satisfaction scores calculated for every user, checks the product name corresponding to the at least one checked personal food satisfaction score, respectively, and selects the checked product name as a customer satisfying product.

3. The service providing device of claim 2, wherein the control unit calculates a plurality of Euclid distance based similarity based on the calculated personal food satisfaction score and the personal food satisfaction score calculated for the product name ordered by another user device which is stored in advance in the storage unit, calculates a total score for every user based on the calculated Euclid distance based similarity for the plurality of products, checks at least one user corresponding to another predetermined number of higher total scores among the calculated total scores for every user, and selects a product which is not ordered in the user device, among the plurality of products ordered by at least one user, based on the payment information paid by the checked at least one user, as an association analysis based recommended product.

4. The service providing device of claim 2, wherein the control unit calculates a customer satisfaction score for every food based on the personal food satisfaction score calculated for the user device, the personal food satisfaction score calculated for the product name ordered by another user device which is stored in advance in the storage unit, a click through rate (CTR) for every product, and a number of times of downloading a coupon for every product, checks at least one customer satisfaction score for every product corresponding to another predetermined number of higher customer satisfaction scores for every food among the calculated customer satisfaction scores for every food, and selects at least one product corresponding to the checked at least one customer satisfaction score for every product as the most popular product of the store of the advertiser.

5. The service providing device of claim 1, wherein the control unit calculates the advertising exposing time of the advertising corresponding to the selected product for every recommendation type respectively based on the click through rate of the advertising corresponding to the product for every recommendation type, the click through rate of the advertising corresponding to the entire products for every recommendation type, and the entire impressions of the advertising corresponding to the product for every recommendation type.

6. A control method of a service providing device, the control method comprising:
receiving response information, payment information, and store information which are transmitted from a POS terminal and generated in a user device, by means of a communication unit;
selecting respectively one or more products for every recommendation type, including a customer satisfying food item, an association analysis based food item, and the most popular food item of a store of an advertiser based on the received response information, payment information, and store information and information related to the store equipped with the POS terminal which is stored in advance in the storage unit, by mean of the control unit;
calculating the advertising exposing time of the advertising corresponding to the selected product for every recommendation type respectively based on the click through rate of the advertising corresponding to the product for every recommendation type, the click through rate of the advertising corresponding to the entire products for every recommendation type, and the entire impressions of the advertising corresponding to the product for every recommendation type, by means of the control unit; and
providing the advertising corresponding to the selected product for every recommendation type according to the calculated advertising exposing time to one or more user devices, by means of the control unit.

7. The control method of claim 6, wherein the selecting of one or more products for every recommendation type includes: calculating a personal food satisfaction score for every product corresponding to the customer satisfying food item based on the food satisfaction score for every product included in the response information, payment date and time information included in the payment information, price information for every order product included in the payment information, and the entire food price paid at every date in the store which is stored in the storage unit, by means of the control unit;
checking at least one personal food satisfaction score corresponding to the predetermined number of higher personal food satisfaction scores among a plurality of personal food satisfaction score calculated for every user;
checking respectively the product name corresponding to the checked at least one personal food satisfaction score; and
selecting the checked product name as a customer satisfying product.

8. The control method of claim 6, wherein the selecting of one or more products for every recommendation type includes: by means of the control unit,
calculating a plurality of Euclid distance based similarity based on the calculated personal food satisfaction score for every product and the personal food satisfaction score calculated for a product name which is ordered in another user device stored in advance in a storage unit;
calculating a total scores for every user based on the calculated Euclid distance based similarity for the plurality of products;
checking at least one user corresponding to the predetermined number of higher total scores, among the calculated total scores for every user; and
selecting a product which is not ordered in the user device, among a plurality of products ordered by at least one user as an association analysis based recommendation product based on the checked payment information paid by the at least one user.

9. The control method of claim 6, wherein the selecting of one or more products for every recommendation type respectively includes: by means of the control unit,
calculating a customer satisfaction score for every food, based on the personal food satisfaction score calculated for the user device, a personal food satisfaction score calculated for the product name ordered by another user device which is stored in advance in a storage unit, a click through rate (CTR) for every product, and a number of times of downloading the coupon for every product;
checking at least one customer satisfaction score for every product corresponding to another predetermined number of higher customer satisfaction scores for every food, among the calculated customer satisfaction scores for every food; and
selecting at least one product corresponding to checked at least one customer satisfaction score for every product as the most popular product in the store of the advertiser.

10. A non-transitory computer readable storage medium having a computer program recorded thereon configured to perform the method according to claim 6.

11. An advertising product recommending system, comprising:
a user device which transmits response information for evaluation information which is transmitted correspondingly to order information;
a POS terminal which performs a payment function for a payment amount corresponding to the order information by interworking with the user device, and transmits the response information, payment information, and store information;
a service providing device which selects a customer satisfying food item, an association analysis based food item, and the most popular food item of a store of an advertiser respectively based on the received response information, payment information, and store information and information related to the store equipped with the POS terminal which is stored in advance, calculates an advertising exposing time of an advertising corresponding to the selected product for every recommendation type respectively, and provides the advertising corresponding to the selected product for every recommendation type according to the calculated advertising exposing time to one or more user devices; and
an advertising terminal which performs an advertising cost calculating function corresponding to a number of actually used coupons, by interworking with the service providing device.

12. A non-transitory computer readable storage medium having a computer program recorded thereon configured to perform the method according to claim 7.

13. A non-transitory computer readable storage medium having a computer program recorded thereon configured to perform the method according to claim 8.

14. A non-transitory computer readable storage medium having a computer program recorded thereon configured to perform the method according to claim 9.
